(19) United States
(12) Patent Application Publication
(10) Pub. No.: US 2018/0088429 A1
(43) Pub. Date: Mar. 29, 2018

(54) Color Electronic Paper and Manufacturing Method Thereof

(71) Applicant: BOE TECHNOLOGY GROUP CO., LTD., Beijing (CN)

(72) Inventor: Xin GU, Beijing (CN)

(21) Appl. No.: 15/717,084

(22) Filed: Sep. 27, 2017

(30) Foreign Application Priority Data
Sep. 29, 2016 (CN) 201610865675.1

(51) Int. Cl. G02F 1/157

(52) U.S. Cl. CPC G02F 1/157

(57) ABSTRACT

A color electronic paper and a manufacturing method thereof are provided. The color electronic paper comprises: a first substrate; a second substrate arranged opposite to the first substrate; and a plurality of pixel units provided between the first substrate and the second substrate, wherein each of the plurality of pixel units comprises: a first electrode provided on the first substrate; a microstructure provided on the first substrate; a second electrode provided on the second substrate and facing to the first substrate, and the second electrode being capable of reflecting light incident onto a surface thereof; a color filter provided on a side of the second electrode close to the first substrate; a medium layer provided between the microstructure and the color filter, and wherein a refractive index of the medium layer is capable of being changed by an electric field generated between the first electrode and the second electrode.

### CROSS REFERENCE TO RELATED APPLICATION

The present application claims priority to the application No. 201610865675.1, entitled “Color Electronic Paper and Manufacturing Method Thereof”, filed on Sep. 29, 2016, which is hereby incorporated by reference in its entirety

### FIELD OF THE INVENTION

The present disclosure relates to the field of display technology, and in particular, relates to an color electronic paper and a manufacturing method thereof.

### BACKGROUND OF THE INVENTION

Electronic paper is a novel electronic display device. Electronic paper products at present are generally manufactured by using cholesteric liquid crystal display technology, electrophoresis display technology (EPD), electrowetting display technology or the like. The most promising technological approach is electrophoresis display technology, the most applied medium of which is E-ink.

Electrophoresis (EP) is a phenomenon that charged particles move, under the effect of an electric field, toward an oppositely charged electrode. A display panel manufactured by using electrophoresis is an electrophoresis display panel. As shown in FIG. 1, the electronic paper using electrophoresis to achieve the effect of display contrast includes an upper substrate and a lower substrate with a number of microcapsules arranged therebetween (the diameter of the microcapsules is in the micron order), wherein each microcapsule contains therein a number of charged black particles and charged white particles, polarities of charges of the black particles and the white particles being opposite (+ and − respectively), and the black particles and the white particles moving up and down between the upper substrate and the lower substrate, under the effect of an electric field applied thereto. Thus, once a certain voltage is applied properly to the microcapsules, the charged particles can be caused to move to generate different combinations of white and black particles, eventually achieving graphic and textual display.

It is found by studies that, when the electrophoresis phenomenon occurs, electrophoresis speed is mainly associated with factors, such as viscosity of electrophoresis liquid, charge quantity of particles (permanently charged or charged by induction), dielectric properties of electrolyte, amplitude of applied electric field, distance between the electrodes. The electrophoresis speed affects the response speed of the electronic paper.

Present studies on the electronic paper are mainly focused on design of a driving structure (for example, a TFT). Since E-ink is generally used to realize white and black display, and color display cannot be realized, the current electronic paper can mostly display a black and white picture, which greatly limits the application of electronic paper.

Therefore, how to design an electronic paper which can realize color display and enrich the display colors of the electronic paper has become a technical problem to be solved urgently.

### SUMMARY OF THE INVENTION

In view of at least one of problems in the prior art, the present disclosure provides a color electronic paper which can realize color display and a manufacturing method thereof.

A solution adopted in the present disclosure to solve the above problem is a color electronic paper comprising:

a first substrate;

a second substrate arranged opposite to the first substrate; and

a plurality of pixel units provided between the first substrate and the second substrate,

wherein each of the plurality of pixel units comprises:
a first electrode provided on the first substrate;
a microstructure provided on the first substrate;
a second electrode provided on the second substrate and facing to the first substrate, and the second electrode being capable of reflecting light incident onto a surface thereof;
a color filter provided on a side of the second electrode close to the first substrate;
a medium layer provided between the microstructure and the color filter, and

wherein a refractive index of the medium layer is capable of being changed by an electric field generated between the first electrode and the second electrode.

Optionally, the medium layer comprises an electrochromic layer, an ion storage layer, and an electrolyte layer disposed between the electrochromic layer and the ion storage layer.

Optionally, the first electrode is provided between the first substrate and the microstructure.

Optionally, the electrochromic layer has a pattern matching with the microstructure so that the electrochromic layer is completely in contact with the microstructure.

Optionally, the first electrode is provided on a side of the microstructure close to the second substrate.

Optionally, the medium layer is provided between the first electrode and the color filter.

Optionally, the first electrode has an uniform thickness and is completely in contact with the microstructure.

Optionally, the electrochromic layer has a pattern matching with the first electrode so that the electrochromic layer is completely in contact with the first electrode.

Optionally, the electrochromic layer has a thickness ranging from 100 nm to 10 μm, and the ion storage layer has a thickness ranging from 10 nm to 10 μm.

Optionally, a refractive index of the microstructure is larger than 1.7.

Optionally, the microstructure includes a plurality of protrudent structures arranged in a matrix, and the protrudent structure is selected from the group consisting of a hemispherical shape, a quadrangular pyramid shape and a conic shape.

Optionally, the color electronic paper further comprises pixel isolation walls provided between the first substrate and the second substrate, for dividing the first substrate and the second substrate into pixel units.

Optionally, a color of the color filter is selected from the group consisting of red, green, blue and black, and color filters of any two adjacent pixel units having different colors.

Optionally, the first electrodes of the pixel units are formed as an integral structure, or, the second electrodes of the pixel units are formed as an integral structure.

A solution adopted in the present disclosure to solve the above problem is a manufacturing method of a color electronic paper, comprising:

dividing a first substrate and a second substrate into a plurality of pixel unit regions;

forming a microstructure on the first substrate for each of the plurality of pixel unit regions;

forming a first electrode on the first substrate by a patterning process for each of the plurality of pixel unit regions;

forming a second electrode on a second substrate by a patterning process for each of the plurality of pixel unit regions, wherein the second electrode being capable of reflecting light incident onto a surface thereof;

forming a color filter on a side of the second electrode far from the second substrate for each of the plurality of pixel unit regions;

forming a medium layer to be provided between the first substrate and the second substrate; and

Assembling the first substrate and the second substrate to form a cell,

wherein a refractive index of the medium layer is capable of being changed by an electric field generated between the first electrode and the second electrode,

Optionally, the step of forming the microstructure on the first substrate further comprises:

forming a transparent material film on the first substrate; and

performing a patterning process on the transparent material film to form the microstructure.

Optionally, the step of forming the microstructure is performed before the step of forming the first electrode, and the step of forming the microstructure on the first substrate further comprises:

forming the microstructure on a side of the first substrate close to the second substrate, and

the step of forming the first electrode on the first substrate further comprising:

forming the first electrode on a side of the microstructure close to the second substrate so that the first electrode has an uniform thickness and is completely in contact with the microstructure.

Optionally, the step of forming the first electrode is performed before the step of forming the microstructure, and the step of forming the first electrode on the first substrate further comprises:

forming the first electrode on a side of the first substrate close to the second substrate, and

the step of forming the microstructure on the first substrate further comprises:

forming the microstructure on a side of the first electrode close to the second substrate.

Optionally, the medium layer comprises an electrochromic layer, an ion storage layer, and an electrolyte layer disposed between the electrochromic layer and the ion storage layer; the step of forming the medium layer to be provided between the first substrate and the second substrate further comprises:

forming the electrochromic layer on a side of the microstructure close to the second substrate;

forming the ion storage layer on a side of the color filter far from the second substrate; and

dripping electrolyte on the first substrate having the electrochromic layer formed thereon or the second substrate having the ion storage layer formed thereon to form the electrolyte layer.

Optionally, the step of dividing the first substrate or the second substrate into a plurality of pixel unit regions further comprises:

forming pixel isolation walls on the first substrate or the second substrate to dividing the first substrate or the second substrate into the plurality of pixel unit regions.

### BRIEF DESCRIPTION OF THE DRAWINGS

FIG. 1 is a schematic diagram of the operation principle of an existing electronic paper;

FIG. 2A is a schematic diagram illustrating color display realized by a color electronic paper according to a first embodiment of the present disclosure;

FIG. 2B is a schematic diagram illustrating color display realized by another color electronic paper according to the first embodiment of the present disclosure;

FIG. 3 is a schematic diagram illustrating white display realized by the color electronic paper according to the first embodiment of the present disclosure;

FIG. 4 is a flowchart of a manufacturing method of a color electronic paper according to a second embodiment of the present disclosure;

FIG. 5 is a schematic diagram of protrudent structures having hemispherical shapes, of the color electronic paper according to the first embodiment of the present disclosure;

FIG. 6 is a schematic diagram of protrudent structures having quadrangular pyramid shapes, of the color electronic paper according to the first embodiment of the present disclosure;

FIG. 7 is a schematic diagram of protrudent structures having conic shapes, of the color electronic paper according to the first embodiment of the present disclosure.

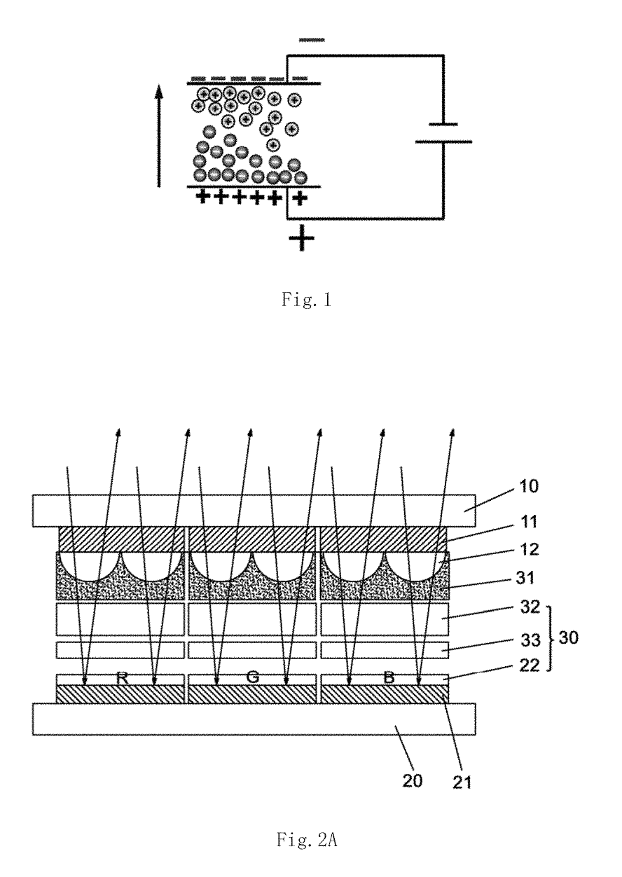

Reference numerals: 10-first substrate; 11-first electrode; 12-microstructure; 20-second substrate; 21-second electrode; 22-color filter; 30-medium layer; 31-electrochromic layer; 32-electrolyte layer; 33-ion storage layer; 35-pixel isolation wall.

### DETAILED DESCRIPTION OF THE EMBODIMENTS

To make the person skilled in the art better understand the technical solution of the present disclosure, the present disclosure is further described below in detail in conjunction with the accompanying drawings and the specific embodiments.

### First Embodiment

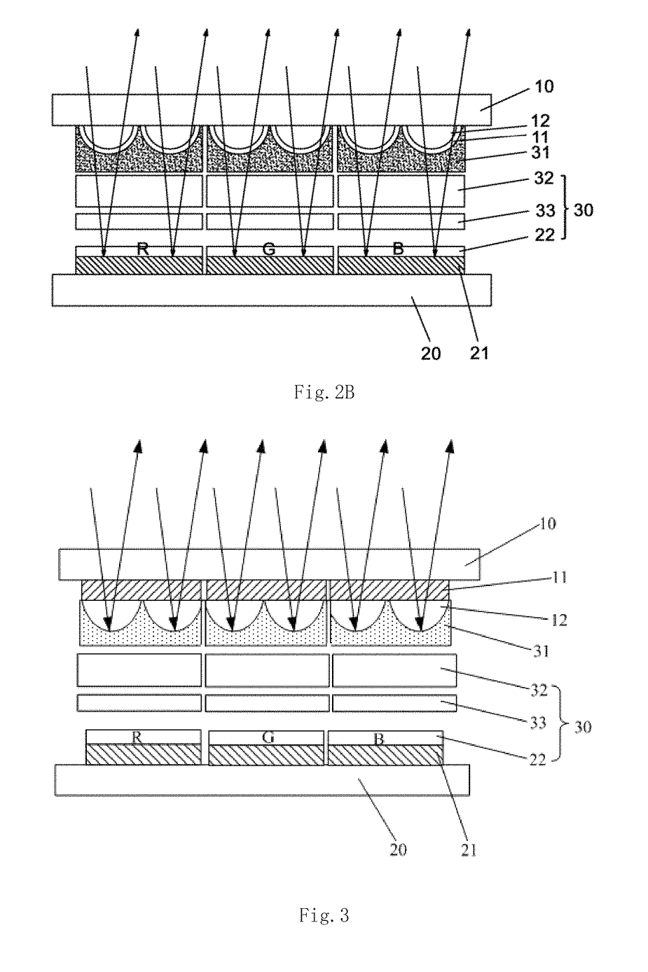

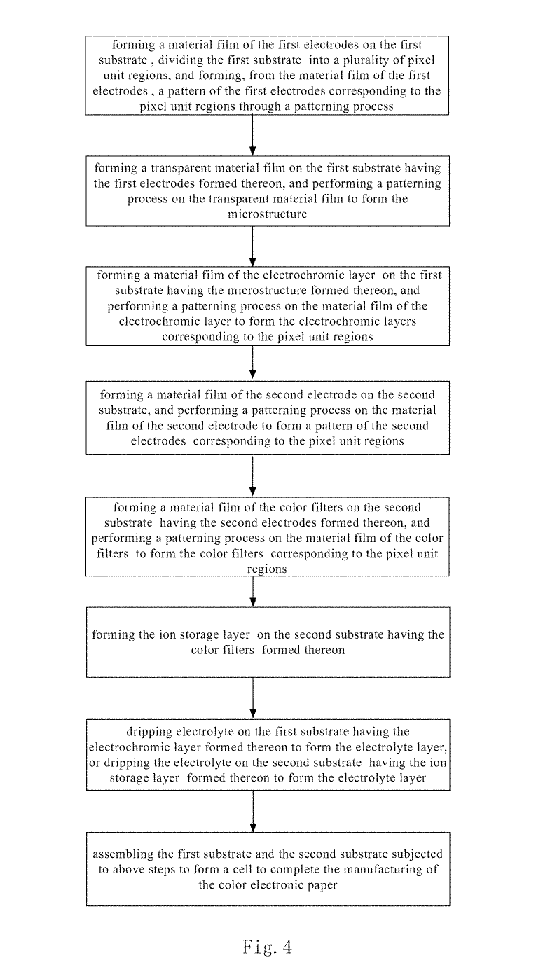

With reference to FIGS. 2A, 2B and 3, this embodiment provides a color electronic paper comprising a first substrate 10 and a second substrate 20 arranged opposite to each other. A microstructure 12 is provided on a side of the first substrate 10 close to the second substrate 20. The color electronic paper is divided into a plurality of pixel units, each of the plurality of pixel units comprises: a first electrode 11 provided on the first substrate 10, a second electrode 21 and a color filter 22 provided on the second substrate 20, wherein the color filter 22 is provided on a side of the second electrode 21 close to the first substrate 10 and the second electrode 21 can reflect light incident onto a surface thereof; a medium layer 30 provided on a side of the microstructure 12 close to second substrate 20, wherein a refractive index of the medium layer 30 can be changed by an electric field generated between the first electrode 11 and the second electrode 21.

In the electronic paper of the present embodiment, each pixel unit has the medium layer 30 provided therein, and the medium layer 30 is provided between the first electrode 11 and the second electrode 21, so that under the control of the electric field generated by applying a voltage to the first electrode 11 and the second electrode 21, the refractive index of the medium layer 30 can be changed. Particularly, when a voltage is applied to the first electrode 11 and the second electrode 21 so that the refractive index of the medium layer 30 is equal to that of the microstructure 12, external light can successively passes through the first electrode 11, the microstructure 12, the medium layer 30 and the color filter 22 to reach the second electrode 21, and then light is reflected by the second electrode 21, and the reflected light is emitted out by sequentially passing through the color filter 22, the medium layer 30, the microstructure 12 and the first electrode 11, and finally, light having a same color as the color filter 22 is emitted from a display surface side of the first substrate 10. When a voltage is applied to the first electrode 11 and the second electrode 21 so that the refractive index of the medium layer 30 is smaller than that of the microstructure 12, total reflection of the external light occurs at a contact interface between the microstructure 12 and the medium layer 30 so as to realize white display. It can be seen from above that the electronic paper provided in the present embodiment can realize color display. Optionally, the second electrode 21 in this embodiment may be made of an opaque material and may reflect light incident thereto. Further optionally, a reflector is provided on a side of the second electrode 21 close to the color filter, which can reflect light passing through the color filter and being incident thereto.

Optionally, in the present embodiment, the first electrode 11 is provided on a side of the first substrate 10 close to the second substrate 20, and the second electrode 21 and the color filter 22 are successively provided on a side of the second substrate 20 close to the first substrate 10, that is, the second electrode 21 is provided on the side of the second substrate 20 close to the first substrate 10, and the color filter 22 is provided on a side of the second electrode 21 close to the first substrate 10. With thus arrangement, the electric field generated by applying a voltage to the first electrode 11 and the second electrode 21 can effectively act on the medium layer 30. Alternatively, the first electrode 11 may be provided on a side of the first substrate 10 far from the second substrate 20, and the color filter 22 and the second electrode 21 are successively provided on a side of the second substrate 20 far from the first substrate 10, that is, the color filter 22 is provided on the side of the second substrate 20 far from the first substrate 10, and the second electrode 21 is provided on a side of the color filter 22 far from the first substrate 10.

In an implementation of the present embodiment, the medium layer 30 consists of an electrochromic layer 31, an ion storage layer 33, and an electrolyte layer 32 disposed between the electrochromic layer 31 and the ion storage layer 33.

Specifically, each of the pixel units of the color electronic paper comprises: the first electrode 11 provided on the first substrate 10; the microstructure 12 provided on a side of the first electrode 11 close to the second substrate 20 (the refractive index of the microstructure 12 is equivalent to or same as that of the first electrode 11); an electrochromic layer 31, which is in contact with the microstructure 12; an electrolyte layer 32 provided on a side of the electrochromic layer 31 close to the second substrate 20; an ion storage layer 33 provided on a side of the electrolyte layer 32 close to the second substrate 20; a color filter 22 and a second electrode 21, which are successively provided on the side of the second substrate 20 close to the first substrate 10, wherein the second electrode 21 is provided on the side of the second substrate 20 close to the first substrate 10, and the color filter 22 is provided on the side of the second electrode 21 close to the first substrate 10.

It should be noted that, since the refractive index of the microstructure 12 is equivalent to or the same as that of the first electrode 11, positions of the microstructure 12 and the first electrode 11 may be interchanged. That is, the electrochromic layer 31 may be in contact with the first electrode 11, as shown in FIG. 2B. In a case that the first electrode 11 is provided between the microstructure 12 and the medium layer 30, optionally, the first electrode 11 may have an uniform thickness, and the first electrode 11 is completely in contact with the microstructure 12 and one side of the electrochromic layer 31 may be completely in contact with the first electrode 11.

For example, when a voltage is applied to the first electrode 11 and the second electrode 21, the electrochromic layer 31 is subjected to an oxidation-reduction reaction under the effect of the electrolyte in the electrolyte layer 32, thus the refractive index of the electrochromic layer 31 is changed, and in a case that the refractive index of the electrochromic layer 31 is controlled to be equal to that of the microstructure 12, external light may transmit through the microstructure 12 to be incident onto the color filter 22 and then may be reflected by the second electrode 21, and finally color light is emitted out. Therefore, color display is realized. In a case that the refractive index of the electrochromic layer 31 is controlled to be smaller than that of the microstructure 12, when the external light enters into the microstructure 12, total reflection of the external light occurs at a contact interface between the microstructure 12 and the medium layer 30, and white light may be emitted out so as to realize white display. During color display and white display, the ion storage layer 33 may maintain current refraction index of the electrochromic layer 31 so as to realize a bistable state of the color electronic paper.

The electrochromic layer 31 has a pattern matching with the microstructure 12 (for example, the microstructure 12 may be of a globular shape, and the electrochromic layer 31 is of an inner concave structure), so that the electrochromic layer 31 may be completely in contact with the microstructure 12. Therefore, during white display, the external light may be reflected out of the microstructure 12 to the most extent at the interface at which the electrochromic layer 31 and the microstructure 12 are in contact with each other. Optionally, the electrochromic layer 31 has a thickness ranging from 100 nm to 10 μm. The “thickness” here means a thickness at a portion of the electrochromic layer 31 having the maximum thickness. Certainly, the thickness may be set as needed.

Optionally, the ion storage layer 33 has a thickness ranging from 10 nm to 10 μm, certainly, it may also be set as needed.

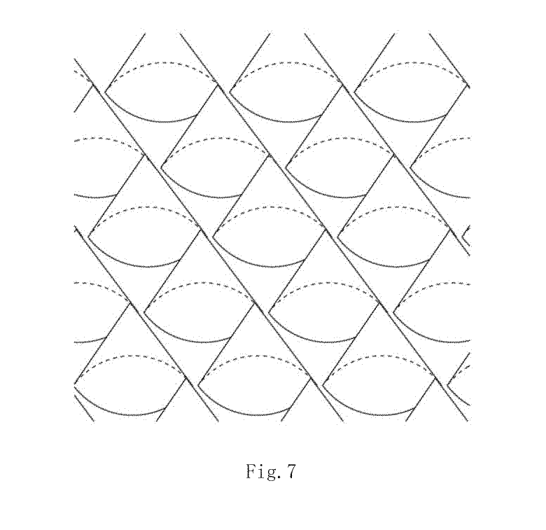

Optionally, a refractive index of the microstructure 12 is larger than 1.7. The microstructure 12 consists of a plurality of protrudent structures arranged in a matrix, and the protrudent structure is selected from the group consisting of a hemispherical shape, a quadrangular pyramid shape and a conic shape, as shown in FIGS. 5 to 7.

The above color electronic paper may further comprises pixel isolation walls 35 provided between the first substrate 10 and the second substrate 20, for dividing the first substrate and the second substrate into pixel units. The pixel isolation walls may prevent crosstalk of colors of the pixel units during color display. Certainly, in a case that the electrolyte in the electrolyte layer 32 in this embodiment is in a gel state, the pixel isolation walls 35 are unnecessary. The pixel isolation walls 35 in figures are only illustrative, but not to limit the disclosure.

Color of the color filter 22 of the color electronic paper in this embodiment may be selected from the group consisting of red, green, blue and black, and color filters of any two adjacent pixel units has different colors. Certainly, colors are not limited thereto and the color filter may be of other color.

Optionally, the first electrodes 11 of the pixel units may be formed as an integral plate electrode, so that the plate electrode may used as a common electrode, and electric fields may generated in the pixel units by applying voltages between the common electrode and the second electrodes.

Optionally, the second electrodes 21 of the pixel units may be formed as an integral plate electrode, so that the plate electrode may used as a common electrode, and electric fields may generated in the pixel units by applying voltages between the common electrode and the first electrodes.

By forming the first electrodes or the second electrodes as an integral plate electrode, complicates of control and wiring may be decreased and the cost may also be reduced.

### Second Embodiment

The present embodiment provides a manufacturing method of a color electronic paper, which can manufacture the color electronic paper in the first embodiment. The manufacturing method comprises: forming a microstructure 12 on the first substrate 10; dividing the first substrate 10 into a plurality of pixel unit regions; forming a first electrode 11 on the first substrate 10 for each of the plurality of pixel unit regions; successively forming a second electrode 21 and a color filter 22 on a second substrate 20 for each of the plurality of pixel unit regions, wherein the second electrode 21 can reflect light incident onto a surface thereof; forming a medium layer 30 to be provided between the first substrate 10 and the second substrate 20, wherein a refractive index of the medium layer 30 can be changed by an electric field generated between the first electrode 11 and the second electrode 21; and finally assembling the first substrate 10 and the second substrate 20 to form a cell so as to form the color electronic paper.

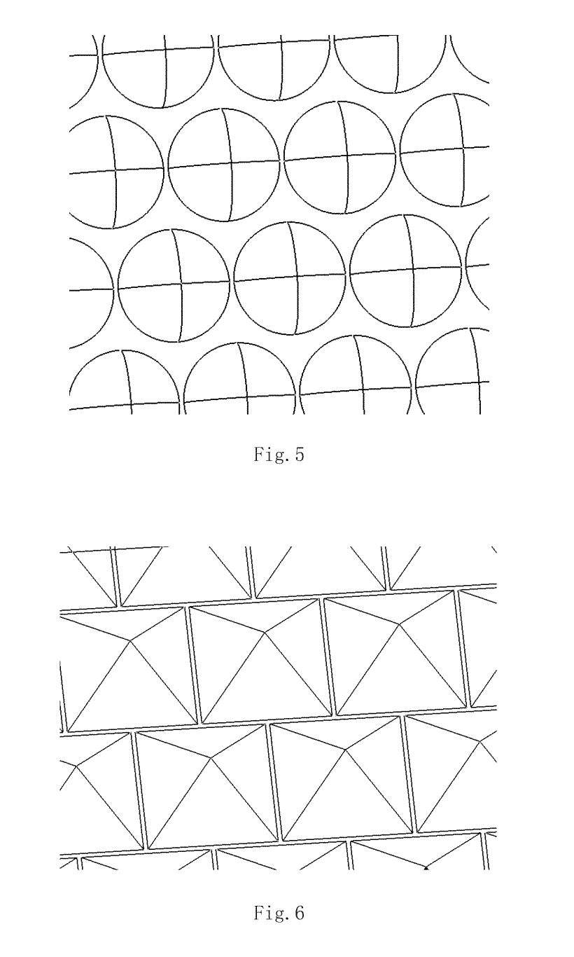

The medium layer 30 may include an electrochromic layer 31, an ion storage layer 33 and an electrolyte layer 32 provided between the electrochromic layer 31 and the ion storage layer 33. The manufacturing method of the color electronic paper in the present embodiment will be described in detail below in combination with a specific manufacturing procedure as shown in FIG. 4. In the following steps, it is feasible to form layers on the first substrate 10 first or form layers on the second substrate 20 first. The present embodiment is described by taking the case of forming the layers on the first substrate 10 first and then forming layers on the second substrate 20 as an example. In the following steps, a patterning process may only include a lithography process, or, include a lithography process, an etching process and other processes for forming a predetermined pattern such as printing and inkjet. The lithography process refers to a process, consisting of processes such as film forming, exposure, development and so on, for forming a pattern by using photoresist, a mask and an exposure machine. The film forming process may be performed by depositing, coating or sputtering. A corresponding patterning process may be selected depending on a structure to be formed in the present embodiment. The manufacturing method of the present embodiment may comprise following steps:

Step 1, forming a material film of the first electrodes 11 on the first substrate 10, dividing the first substrate 10 into a plurality of pixel unit regions, and forming, from the material film of the first electrodes 11, a pattern of the first electrodes 11 corresponding to the pixel unit regions through a patterning process.

Step 2, forming a transparent material film on the first substrate 10 having the first electrodes 11 formed thereon, and performing a patterning process on the transparent material film to form the microstructure 12, wherein the microstructure 12 may be formed by a nano-imprint method.

Step 3, forming a material film of the electrochromic layer 31 on the first substrate 10 having the microstructure 12 formed thereon, and performing a patterning process on the material film of the electrochromic layer 31 to form the electrochromic layers 31 corresponding to the pixel unit regions.

Step 4, forming a material film of the second electrode 21 on the second substrate 20, and performing a patterning process on the material film of the second electrode 21 to form a pattern of the second electrodes 21 corresponding to the pixel unit regions.

Step 5, forming a material film of the color filters 22 on the second substrate 20 having the second electrodes 21 formed thereon, and performing a patterning process on the material film of the color filters 22 to form the color filters 22 corresponding to the pixel unit regions. Optionally, colors of two adjacent color filters 22 are different.

Step 6, forming the ion storage layer 33 on the second substrate 20 having the color filters 22 formed thereon.

Step 7, dripping electrolyte on the first substrate 10 having the electrochromic layer 31 formed thereon to form the electrolyte layer 32, or dripping the electrolyte on the second substrate 20 having the ion storage layer 33 formed thereon to form the electrolyte layer 32.

Step 8, assembling the first substrate 10 and the second substrate 20 subjected to above steps to form a cell to complete the manufacturing of the color electronic paper.

It should be noted that the order of step 1 for forming the first electrodes 11 and step 2 for forming the microstructure 12 may be interchanged. For example, step 1 may be as follows: forming a transparent material film on the first substrate 10, and performing a patterning process on the transparent material film to form the microstructure 12, wherein the microstructure 12 may be formed by a nano-imprint method, and accordingly, step 2 may be as follows: forming a material film of the first electrodes 11 on the first substrate 10 having the microstructure 12 formed thereon, dividing the first substrate 10 into a plurality of pixel unit regions, and forming, from the material film of the first electrodes 11, a pattern of the first electrodes 11 corresponding to the pixel unit regions through a patterning process.

Furthermore, the step of dividing the first substrate 10 into a plurality of pixel unit regions may further comprise:

forming pixel isolation walls, so as to divide the first substrate 1.0 into a plurality of pixel unit regions. Certainly, it is also feasible for forming the pixel isolation walls on the second substrate 20.

In addition, the steps for forming the electrochromic layer 31, the ion storage layer 33, and the electrolyte layer 32 are just illustrative, but not limited. Manners for forming the electrochromic layer 31, the ion storage layer 33, and the electrolyte layer 32 may be selected as needed, so long as resultant arrangement of the electrochromic layer 31, the ion storage layer 33, and the electrolyte layer 32 may be that as shown in FIG. 2A, FIG. 2B or FIG. 3.

In the color electronic paper manufactured by the above method, when a voltage is applied to the first electrode 11 and the second electrode 21, the electrochromic layer 31 is subjected to oxidation-reduction reaction under the effect of the electrolyte in the electrolyte layer 32, thus the refractive index of the electrochromic layer 31 is changed, and when the refractive index of the electrochromic layer 31 is controlled to be equal to that of the microstructure 12, external light may transmit through the microstructure 12 to be incident onto the color filters 22, and then may be reflected by the second electrode 21, and finally color light is emitted out. Therefore, color display is realized. In a case that the refractive index of the electrochromic layer 31 is controlled to be smaller than that of the microstructure 12, when the external light enters into the microstructure 12, total reflection of the external light occurs at a contact interface between the microstructure 12 and the medium layer 30, and white light may be emitted out through the first substrate 10 so as to realize white display. During color display and white display, the ion storage layer 33 may maintain current refraction index of the electrochromic layer 31 so as to realize a bistable state of the color electronic paper.

The present disclosure has the following advantages:

Each pixel unit of the color electronic paper in the present disclosure has a medium layer provided therein, and the refractive index of the medium layer is changed under the control of the electric field generated by applying a voltage to the first electrode and the second electrode. Specifically, when a voltage is applied to the first electrode and the second electrode so that the refractive index of the medium layer is equal to that of the microstructure, external light may successively transmit through the microstructure, the medium layer, the color filter to reach the reflector and then may be reflected by the reflector, the reflected light may successively transmit through the color filter, the medium layer and the microstructure to emit out, therefore light with a same color as the color filter is emitted from a display surface side of the first substrate. When a voltage is applied to the first electrode and the second electrode so that the refractive index of the medium layer is smaller than that of the microstructure, total reflection of the external light occurs at a contact interface between the microstructure and the medium layer, realizing white display. It can be seen that the color electronic paper provided in the present disclosure may realize color display.

It can be understood that the above embodiments are only exemplary embodiments for illustrating the principle of the present disclosure; however, the present disclosure is not limited thereto. For those of ordinary skill in the art, various modifications and improvements can be made without departing from the spirit and essence of the present disclosure, and these modifications and improvements are also encompassed within the protection scope of the present disclosure.

1. A color electronic paper comprising:
a first substrate;
a second substrate arranged opposite to the first substrate; and
a plurality of pixel units provided between the first substrate and the second substrate,
wherein each of the plurality of pixel units comprises:
a first electrode provided on the first substrate;
a microstructure provided on the first substrate;
a second electrode provided on the second substrate and facing to the first substrate, and the second electrode being capable of reflecting light incident onto a surface thereof;
a color filter provided on a side of the second electrode close to the first substrate;
a medium layer provided between the microstructure and the color filter, and
wherein a refractive index of the medium layer is capable of being changed by an electric field generated between the first electrode and the second electrode.

2. The color electronic paper of claim 1, wherein the medium layer comprises an electrochromic layer, an ion storage layer, and an electrolyte layer disposed between the electrochromic layer and the ion storage layer.

3. The color electronic paper of claim 2, wherein the first electrode is provided between the first substrate and the microstructure.

4. The color electronic paper of claim 3, wherein the electrochromic layer has a pattern matching with the microstructure so that the electrochromic layer is completely in contact with the microstructure.

5. The color electronic paper of claim 2, wherein the first electrode is provided on a side of the microstructure close to the second substrate.

6. The color electronic paper of claim 5, wherein the medium layer is provided between the first electrode and the color filter.

7. The color electronic paper of claim 6, wherein the first electrode has an uniform thickness and is completely in contact with the microstructure.

8. The color electronic paper of claim 7, wherein the electrochromic layer has a pattern matching with the first electrode so that the electrochromic layer is completely in contact with the first electrode.

9. The color electronic paper of claim 2, wherein the electrochromic layer has a thickness ranging from 100 nm to 10 μm, and the ion storage layer has a thickness ranging from 10 nm to 10 μm.

10. The color electronic paper of claim 1, wherein a refractive index of the microstructure is larger than 1.7.

11. The color electronic paper of claim 1, wherein the microstructure includes a plurality of protrudent structures arranged in a matrix, and the protrudent structure is selected from the group consisting of a hemispherical shape, a quadrangular pyramid shape and a conic shape.

12. The color electronic paper of claim 1, further comprising pixel isolation walls provided between the first substrate and the second substrate, for dividing the first substrate and the second substrate into pixel units.

13. The color electronic paper of claim 1, wherein a color of the color filter is selected from the group consisting of red, green, blue and black, and color filters of any two adjacent pixel units has different colors.

14. The color electronic paper of claim 1, wherein the first electrodes of the pixel units are formed as an integral structure, or, the second electrodes of the pixel units being formed as an integral structure.

15. A manufacturing method of a color electronic paper, comprising:
dividing a first substrate and a second substrate into a plurality of pixel unit regions;
forming a microstructure on the first substrate for each of the plurality of pixel unit regions;
forming a first electrode on the first substrate by a patterning process for each of the plurality of pixel unit regions;
forming a second electrode on a second substrate by a patterning process for each of the plurality of pixel unit regions, wherein the second electrode is capable of reflecting light incident onto a surface thereof;
forming a color filter on a side of the second electrode far from the second substrate for each of the plurality of pixel unit regions;
forming a medium layer to be provided between the first substrate and the second substrate; and
assembling the first substrate and the second substrate to form a cell,
wherein a refractive index of the medium layer is capable of being changed by an electric field generated between the first electrode and the second electrode.

16. The manufacturing method of claim 15, wherein the step of forming the microstructure on the first substrate further comprises:
forming a transparent material film on the first substrate; and
performing a patterning process on the transparent material film to form the microstructure.

17. The manufacturing method of claim 15, wherein the step of forming the microstructure is performed before the step of forming the first electrode, and the step of forming the microstructure on the first substrate further comprising:
forming the microstructure on a side of the first substrate close to the second substrate, and
the step of forming the first electrode on the first substrate further comprising:
forming the first electrode on a side of the microstructure close to the second substrate so that the first electrode has an uniform thickness and is completely in contact with the microstructure.

18. The manufacturing method of claim 15, wherein the step of forming the first electrode is performed before the step of forming the microstructure, and the step of forming the first electrode on the first substrate further comprises:
forming the first electrode on a side of the first substrate close to the second substrate, and
the step of forming the microstructure on the first substrate further comprises:
forming the microstructure on a side of the first electrode close to the second substrate.

19. The manufacturing method of claim 15, wherein the medium layer comprises an electrochromic layer, an ion storage layer, and an electrolyte layer disposed between the electrochromic layer and the ion storage layer; the step of forming the medium layer to be provided between the first substrate and the second substrate further comprises:
forming the electrochromic layer on a side of the microstructure close to the second substrate;
forming the ion storage layer on a side of the color filter far from the second substrate; and
dripping electrolyte on the first substrate having the electrochromic layer formed thereon or the second substrate having the ion storage layer formed thereon to form the electrolyte layer.

20. The manufacturing method of claim 15, wherein the step of dividing the first substrate or the second substrate into the plurality of pixel unit regions further comprising:
forming pixel isolation walls on the first substrate or the second substrate to dividing the first substrate or the second substrate into the plurality of pixel unit regions.
